(19) United States
(12) Patent Application Publication
(10) Pub. No.: US 2009/0076207 A1
(43) Pub. Date: Mar. 19, 2009

(54) Organosols stabilized by amphiphilic block polymers

(76) Inventors: Mathias Destarac, Paris (FR); Bertrand Pavageau, Villenave D'Ornon (FR); Bruno Tolla, Naperville, IL (US)

Correspondence Address: BUCHANAN, INGERSOLL & ROONEY PC, POST OFFICE BOX 1404, ALEXANDRIA, VA, 22313-1404, US

(21) Appl. No.: 11/919,633

(22) PCT Filed: May 2, 2006
(86) PCT No.: PCT/FR2006/000984

§ 371 Date: Oct. 31, 2007

(30) Foreign Application Priority Data
May 3, 2005 (FR) 0504511

(51) Int. Cl. C08K 3/22; C08L 67/06; C08L 53/00

(52) U.S. Cl. 524/403; 524/413; 524/431; 524/437; 524/539; 524/505

(57) ABSTRACT

Mineral particle dispersions in an organic hydrophobic medium (organosols) are stabilized by amphiphilic block polymers containing R^{A} groups for developing interactions with the surface of the particles and at least one hydrophobic block B having an affinity for the organic medium of the dispersion.

The present invention relates to stabilised dispersions of mineral particles in which the dispersing medium is an organic medium, preferably a hydrophobic organic medium. Such dispersions are generally referred to by the term organosols (organic sols).

A major problem that is encountered with such organosols is the incompatibility between the particles, which are inorganic in nature, and the dispersing medium, which is organic and, more often than not, hydrophobic. In fact, apart from very rare exceptions, the dispersing medium exhibits a very low affinity for the surface of the inorganic particles, which is generally hydrophilic.

This problem of incompatibility is found to be particularly pronounced when the particles have an electric surface charge, as is the case especially with mineral-oxide-based particles, the surface of which generally carries cationic or anionic species. When such surface charges are present, the particles have a tendency to aggregate, which generally results in destabilisation of the organosol, in particular when the particles are of small size, for example when the particles of the organosol have average dimensions of below 1 μm, for example from 1 nm to 500 nm, the particles then developing a considerable exchange surface with the organic medium.

In order to avoid the above-mentioned disadvantages, various types of surface modification of the particles have been envisaged for organosols, in order to make them compatible with the organic dispersing medium.

A first solution that has been proposed in this respect comprises grafting organic chains to the surface of the particles in order to modify their surface and avoid interparticle aggregation. To that end it has been proposed, for example, especially in patent application FR 2 721 615, to modify the surface of the particles by means of agents of the silane type, which allows organic chains to be grafted covalently to the surface of the particles that are to be stabilised. This solution is generally found to be effective, but more often than not it proves to be complex to implement and, in view of the silanes that are most usually available, it is generally limited to the preparation of organosols in which the dispersing medium is non-polar. In addition, the use of silanes results in the generation of alcohols (for example ethanol or methanol) as by-products, which can prove to be disruptive in some applications.

In order to avoid the generation of alcohol, an alternative solution to the use of silanes, which is described especially by Meriguet et al. in Journal of Colloid and Interface Science, 267, pp. 78-85 (2003), comprises using agents of the surface-active type in the dispersion.

Within this context, it is known, especially from FR 2716 388, to use amphiphilic carboxylic acids, such as lauric acid or isostearic acid, in the preparation of organosols based on CeO₂ particles. For the stabilisation of organosols there have also been proposed cationic surface-active agents of the dimethyl-didodecyl-ammonium bromide type and, more recently, anionic surfactants, such as, for example, sodium dodecylbenzenesulfonate, which has been used by Ramakrishna et al. to stabilise organosols based on TiO₂ particles (Langmuir, Vol. 19, pp. 505-508 (2003)).

The sols obtained by using the above surface-active agents are generally relatively stable. However, there are limits to this stability, especially when the organosol is stored or used for prolonged periods, for example when it is employed at elevated temperatures, for example of the order of from 70 to 80° C., and very particularly when it is subjected to strong fluctuations of temperature. Under such conditions, destabilisation of the organosol is observed in the more or less long term, resulting in aggregation and flocculation of the particles (such destabilisation can be demonstrated, for example, by subjecting the organosol to cycles of temperature rise and fall between −20° C. and 90° C.). For many applications, the stability obtained with a surfactant of the isostearic acid type is found to be satisfactory, but it is nevertheless desirable to improve that stability still further, in particular for certain specific applications in which stability over the longer term is required.

Furthermore, the stability of organosols stabilised by surface-active agents is often affected by the introduction of certain formulation additives which tend to embrittle the sol, which can prohibit the use of such additives and consequently limits the fields of application of the organosol.

In addition, the use of the above-mentioned surfactants generally does not allow organosols based on polar dispersing media to be stabilised.

It is an object of the invention to provide organosols that are more stable than the above-mentioned organosols based on surfactants, namely organosols that are stable over long storage periods and that are especially capable of withstanding both heat treatment at temperatures of the order of from 70 to 80° C. and considerable variations in temperature without the structure of the dispersion being substantially affected. The invention aims to achieve that object without having to carry out the covalent grafting of organic chains to the surface of the particles.

Within this context, the invention more specifically aims at providing stabilised organosols which can contain either a polar or non-polar dispersing medium and which preferably allow all the above-mentioned problems that are encountered with the organosols known at present to be avoided.

To that end, according to a first aspect, the present invention relates to a stabilised dispersion of mineral particles within an organic dispersing medium (that is to say, an organosol of the mineral particles) which comprises, as agents for stabilising the dispersion, specific amphiphilic block polymers P. More precisely, the amphiphilic block polymers P comprise:
a hydrophilic block A containing groups R^{A} capable of developing interactions with the surface of the particles; and
at least one hydrophobic block B bonded to the hydrophilic block A and having an affinity in respect of the organic dispersing medium.

The inventors' works have now made it possible to demonstrate that the use of the block polymers P as defined hereinbefore enables particularly effective stabilisation of the dispersion of particles in the organosol to be obtained.

Within the scope of the present description, the term “stabilised dispersion” is understood as meaning a dispersion of particles in a dispersing medium which is preferably a liquid of low viscosity, typically having an intrinsic viscosity of less than or equal to 200 centipoise, and wherein the particles are distributed homogeneously in said dispersing medium, and wherein the homogeneous distribution of the particles is substantially preserved, without any substantial phenomenon of sedimentation of the particles, after storage for one month at 20° C., and more often than not after storage for at least 6 months, or even for 12 months, at 20° C.

The stabilised dispersions of the present invention additionally exhibit good thermal stability, both at high temperatures and under temperature conditions that vary over a wide range.

Accordingly, it is generally noted that, following isothermal heat treatment at a temperature of the order of 70° C. for 1 month, or even for 3 months, the particles of an organosol according to the invention remain distributed homogeneously, without any substantial phenomenon of sedimentation of the particles. More often than not, isothermal heat treatment of an organosol according to the invention for one month at a temperature of 80° C., or even of 90° C., does not lead to destabilisation resulting in phenomena of substantial sedimentation of the particles.

Likewise, the stability is also preserved, without any substantial phenomenon of sedimentation of the particles, if an organosol according to the invention is subjected to temperature cycles between −20° C. and +90° C. for at least 100 hours, and more often than not for at least 200 hours, or even more.

In the context in which it is used in the present description, the expression “without any substantial phenomenon of sedimentation of the particles” denotes the absence of visually detectable sedimentation of the particles. The storage stability and the inhibition of sedimentation phenomena that are obtained with the organosols of the present invention can be quantified more precisely by comparing the quantity of particles present in the dispersed state in the initial organosol and in the organosol after storage.

In the majority of cases, it is noted that, after storage of the organosol under the above-mentioned conditions, at least 80%, and more often than not at least 90%, or even at least 95%, of the particles initially in the dispersed state remain in dispersion, without forming a sediment.

The nature of the mineral particles present in the stabilised dispersions of the invention can vary quite considerably. However, the particles are advantageously particles based on a mineral oxide. They can accordingly be in particular particles based on silica SiO₂ or particles based on a metal oxide, such as cerium oxide CeO₂, titanium oxide TiO₂, zirconium oxide ZrO₂, alumina Al₂O₃, an oxide of iron, such as Fe₂O₃, or a mixture of two or more of those oxides.

The expression “particles based on a mineral oxide” herein denotes particles which are formed wholly or partially by a mineral oxide, preferably selected from the above-mentioned oxides or mixtures thereof. Generally, in a dispersion according to the invention, the particles that are present are constituted mainly by mineral oxide or by a mixture of mineral oxides, that is to say they comprise preferably at least 50% by mass, more advantageously at least 80% by mass, and more preferably at least 90% by mass, of one or more mineral oxides. According to a particular embodiment, the particles that are present are constituted substantially of mineral oxide (namely to the extent of at least 90% by mass, preferably at least 95% by mass, more preferably at least 99% by mass). According to another possible embodiment, the particles can comprise a core based on a first oxide coated with a layer based on a different oxide. They can accordingly be, for example, CeO₂-based particles coated with a layer of silica.

According to a specific embodiment, the oxides present in the particles of the organosols of the invention can be doped with one or more metallic elements. Such a doped oxide can be, for example, silica doped with aluminium cations, or alternatively an oxide of a first metal doped with cations of a different metal.

The content of particles within a dispersion according to the invention can vary quite considerably depending on the applications which are contemplated for the dispersion. However, in the most general case, it is more often than not from 0.1% to 15% by mass, based on the total mass of the dispersion. That range allows there to be obtained organosols of relatively low viscosity which have good fluidity and are easy to handle. Within this context, in order to obtain as low a viscosity as possible, it is preferable for the content to be less than or equal to 13% by mass, more preferably less than or equal to 10% by mass, for example less than or equal to 8% by mass, based on the total mass of the dispersion. In general, however, it is preferred for the organosol to be not too diluted, and it is often found to be preferable for the content of particles to remain at least 0.2% by mass, for example at least 0.4% by mass, based on the total mass of the dispersion. Accordingly, a dispersion according to the invention can typically comprise of the order of from 0.2% to 10% by mass of particles, for example from 0.5 to 5% by mass, based on the total mass of the dispersion.

According to another possible embodiment, an organosol according to the invention can have a content of particles greater than 15%. In that case, the organosol generally has a high viscosity but nevertheless retains its good storage stability properties.

Irrespective of their exact chemical nature, the mineral particles contained in the stabilised dispersions of the invention are generally present within the organosol substantially in the form of individual particles and/or aggregates of particles, which are dispersed in the organic dispersing medium. Each of the objects so dispersed is surrounded by polymers P, which form schematically in the organosol mixed inorganic/organic species comprising (i) a mineral core based on one or more mineral particles and (ii) an organic layer based on the polymers P. The mineral core of those species generally has an average size of below 1 μm, typically below 200 nm, and more often than not below 100 nm, not including the organic layer surrounding it. The average size of the mineral core of the species dispersed in the organosols of the invention can be determined especially by analysis of transmission electron microscope images of samples of the organosol (for example produced by the technique of ultracryotomy).

The specific amphiphilic block polymers P which are used as stabilising agents within the scope of the invention allow to provide stable dispersions wherein the dispersed objects are often in the form of individual particles and/or in the form of aggregates of a plurality of particles which generally have dimensions of the order of magnitude of the individual particles, even when the particles that are present are very small in size, for example of the order of several nanometres or several tens of nanometres. The stability properties imparted by the polymers P to the organosol comprising particles of that size range are found to be surprisingly high in comparison with the results observed when it is attempted to stabilise the sol by means of conventional stabilising agents of the surfactant type, such as, for example, isostearic acid. Those stabilising properties of the polymers P, demonstrated by the inventors, permit the provision, within the scope of the invention, of organosols which comprise dispersed objects of very small dimensions. Accordingly, the mineral objects (individual particles or mineral aggregates) which are dispersed in an organosol according to the invention can typically have an average size of less than or equal to 70 nm, or even 60 nm. Accordingly, the average size of the mineral objects dispersed in the organosol is typically from 1 to 70 nm, typically from 2 to 60 nm, for example from 3 to 50 nm. The average size of the mineral objects to which reference is made here is the average size of the mineral objects themselves, without taking into consideration the layer of organic species (polymers P and, optionally, solvation layer) surrounding the mineral objects.

The stabilised dispersions of the present invention are, specifically, dispersions of mineral objects stabilised within an organic medium. The specific use of the amphiphilic polymers P of the invention confers a great freedom of choice in respect of the organic dispersing medium that can be used. Within this context, the majority of organic media are in fact found to be usable, on condition that there is chosen a polymer P that comprises a hydrophobic block B suited to the medium employed.

It should especially be emphasised that the use of the polymers P according to the invention enables the use of both non-polar and polar organic dispersing media. A “polar medium” is here to be understood as being a medium having a dielectric constant ∈ᵣ greater than 5, the dielectric constant ∈ᵣ to which reference is made here being as defined especially in the work “Solvents and Solvent Effects in Organic Chemistry”, C. Reichardt, VCH, 1988. Examples of polar media which can be mentioned within the scope of the present description include most esters, such as, for example, ethyl acetate, isopropyl palmitate or methoxypropyl acetate; halogenated compounds, such as dichloromethane; alcohols, such as ethanol, butanol or isopropanol; polyols, such as propanediol, butanediol or diethylene glycol; or ketones, such as cyclohexanone or 1-methylpyrrolidin-2-one.

More generally, the organic dispersing medium of the organosols of the invention can vary very considerably. By way of information, the organic dispersing medium can comprise, for example, one or more organic compounds selected from:
aliphatic or cycloaliphatic hydrocarbons, such as hexane, heptane, octane, nonane, decane, cyclohexane, cyclopentane and cycloheptane;
aromatic solvents, such as benzene, toluene, ethylbenzene and xylenes;
mixtures of aromatic and/or aliphatic hydrocarbons, such as mineral spirits or naphthas, liquid naphthenes, or petroleum fractions of the ISOPAR or SOLVESSO type (trade marks filed by EXXON), such as SOLVESSO 100 (mixture based on methylethyl and trimethylbenzene) and SOLVESSO 150 (mixture of alkylbenzenes containing in particular dimethylethylbenzene and tetramethylbenzene);
chlorinated hydrocarbons, such as, for example, chlorobenzene or dichlorobenzene, or chlorotoluene;
aliphatic and cycloaliphatic ethers, such as diisopropyl ether or dibutyl ether;
aliphatic and cycloaliphatic ketones, such as methyl isobutyl ketone, diisobutyl ketone, mesityl oxide or acetone;
aldehydes;
nitrogen-containing solvents, such as acetonitrile;
alcohols having preferably from 1 to 10 carbon atoms, such as ethanol, propanol or butanol;
phenols;
esters, and especially:
   esters obtained from the reaction of carboxylic acids having preferably from 10 to 40 carbon atoms (such as the fatty acids of tall oil, of coconut oil, of soya, of tallow, of linseed oil, oleic acid, linoleic acid, stearic acid and its isomers, pelargonic acid, capric acid, lauric acid, myristic acid, dodecylbenzenesulfonic acid, 2-ethylhexanoic acid, naphthenic acid, palmitic acid or hexoic acid) with alcohols having, for example, from 1 to 8 carbon atoms, such alcohols generally being primary or secondary alcohols (such as isopropanol) or glycols such as glycerol; and mixtures of such esters;
   sulfonic or phosphonic esters, preferably obtained from the reaction of alcohols having advantageously from 1 to 8 carbon atoms with aliphatic sulfonic acids, aliphatic phosphonic acids, alkylarylsulfonic acids or alkylarylphosphonic acids having preferably of the order of from 10 to 40 carbon atoms, such as toluene-sulfonic acid, toluene-phosphonic acid, lauryl-sulfonic acid, lauryl-phosphonic acid, palmityl-sulfonic acid and palmityl-phosphonic acid;
polymerisable monomers, such as styrene and its derivatives, alkyl acrylates, alkyl methacrylates or vinyl esters; as well as mixtures of such monomers;
silicone oils;
essential oils;
organic oils, such as vegetable oils; and
mixtures of the above-mentioned compounds.

Irrespective of the nature of the particles used and of the dispersing medium employed, a suspension according to the invention characteristically comprises amphiphilic block polymers P as defined hereinbefore, which act as stabilising agents. Those polymers P are generally sufficient, on their own, to provide the required stability for the suspension, and they can accordingly be used as the only stabilising agents in the dispersion, to the exclusion of, for example, other agents such as surface-active agents. Nevertheless, according to a possible embodiment of the invention, the polymers P can be used in association with other known stabilising agents, for example surface-active agents such as isostearic acid, or anionic or cationic surface-active agents such as, for example, dimethyl-didodecyl-ammonium bromide or sodium dodecylbenzenesulfonate. In some cases, this type of association can permit particularly effective stabilisation.

Likewise, it is not required, according to the invention, for the particles to be modified by the grafting of covalently bonded groups to their surface.

In general, the choice of polymers P to be used in a dispersion according to the invention depends in particular:
on the nature of the particles used, which determines in particular the groups R^{A} which can be present in block A; and
on the nature of the dispersing medium, in respect of which at least one hydrophobic block B present in the polymer P must exhibit an affinity.

Accordingly, the polymers P specifically comprise groups R^{A} which are capable of developing interactions with the surface of the particles of the organosol, and at least some of which actually develop interactions with the surface of the particles.

Within this context it is advantageous (although not generally required) for the groups R^{A} to be groups that develop, or at least that are capable of developing, interactions of the ionic, complexing or electrostatic bond type with the surface of the particles. To that end, it is preferable to use particles having electrically charged species (cationic or anionic species) at the surface and polymers P comprising, as groups R^{A}, groups having a charge of the opposite sign to that of the species present at the surface of the particles (anionic or cationic groups, respectively).

According to a first variant of the invention, the mineral particles used have a negatively charged surface, and all or some of the groups R^{A} of block A of the polymers P are groups of a cationic nature. Those cationic groups R^{A} are generally associated with negatively charged counter-ions, which can be selected especially from the ions chlorides, bromides, iodides, fluorides, sulfates, methyl sulfates, phosphates, hydrogen phosphates, phosphonates, carbonates and hydrogen carbonates. The counter-ions are preferably hydrogen phosphates, methyl sulfates and/or chlorides.

According to that particular variant of the invention, the particles having a negatively charged surface are typically particles based on silica, and the groups R^{A} of the hydrophilic block A of the polymers P more often than not comprise ammonium groups or quaternary amines. Within this context, block A can typically be a block of the polyamine, polyethyleneimine or polyallylamine type or of the poly(dimethylaminoethyl acrylate) type, which may or may not be quaternised. Alternatively, block A can be a polymer block grafted by cationic groups after its polymerisation. For example, block A can be a halogenated block (such as a poly-p-chloromethylstyrene block) with which there is reacted, after polymerisation, a tertiary amine (for example trimethylamine).

According to an embodiment that is of interest in the case where the mineral particles used have a negatively charged surface, the hydrophilic block A of the polymers P is a homopolymer or a copolymer based on monomers M at least some of which comprise an ethylenic unsaturation and at least one quaternary nitrogen atom or nitrogen atom quaternisable by protonation (that is to say by pH adjustment). Within this context, the hydrophilic block A can, for example, be based on one or more of the following monomers:

monomers of formula (M1):

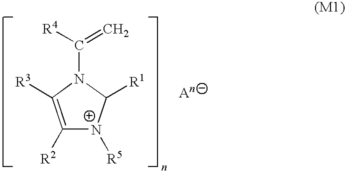

in which:
   A^{n\textcircled{-}} represents an anion Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}
or CH₃—CH₂—OSO₃^{\textcircled{-}},
   the groups R¹ to R⁵, which may be identical or different, each independently of the others represents an alkyl group having from 1 to 20 carbon atoms, a benzyl radical or a hydrogen atom; and
   n has the value 1 or 2;

monomers of formula (M2):

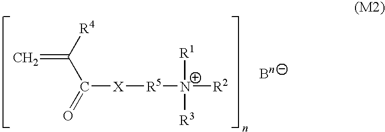

in which:
   X represents a —NH— group or an oxygen atom —O—;
   R4 represents a hydrogen atom or an alkyl group having from 1 to 20 carbon atoms;
   R5 represents an alkenyl group having from 1 to 20 carbon atoms;
   the groups R1, R2 and R3, which may be identical or different, each independently of the others represents an alkyl group having from 1 to 20 carbon atoms;
   B^{n\textcircled{-}} represents an ion Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}
or CH₃—CH₂—OSO₃^{\textcircled{-}}; and
   n has the value 1 or 2;

monomers of formula (M3):

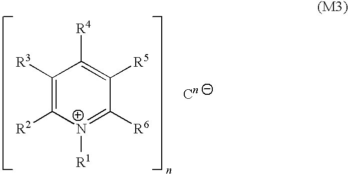

in which:
   one of the groups R¹ to R⁶ represents a —CH═CH2 group and the other groups R¹ to R⁶, which may be identical or different, each independently of the others represents a hydrogen atom or an alkyl radical having from 1 to 20 carbon atoms,
   C^{n\textcircled{-}} represents an ion Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}
or CH₃—CH₂—OSO₃^{\textcircled{-}}; and
   n has the value 1 or 2, or

monomers of formula (M4):

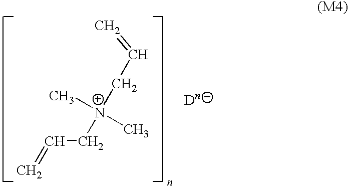

in which:
   D^{n\textcircled{-}} represents an ion Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}
or CH₃—CH₂—OSO₃^{\textcircled{-}}; and
   n has the value 1 or 2.

Preferably, when the mineral particles used have a negatively charged surface, the hydrophilic block A comprises as monomers M monomers selected from:
2-dimethylaminoethyl acrylate (<<ADAM>>);
2-dimethylaminoethyl methacrylate (<<MADAM>>); or
diallyldimethylammonium chloride (<<DADMAC>>).

According to another variant of the invention, the mineral particles present in the organosol have a positively charged surface, and all or some of the groups R^{A} of block A of the polymers P are groups of an anionic nature. Within the scope of this specific embodiment, the particles can be especially particles based on cerium oxide CeO₂, titanium oxide TiO₂ or zirconium oxide ZrO₂, and block A of the polymers P advantageously comprises carboxylate groups (—COO⁻), sulfate groups (—SO₄⁻), sulfonate groups (—SO₃⁻), phosphonate groups (for example in the —PO₃²⁻ form) or phosphate groups (for example in the OPO₃²⁻ form). Particularly advantageously, according to this embodiment, the mineral particles are particles based on cerium oxide CeO₂. In this case in particular, it is advantageous for block A to comprise free —COOH groups, preferably at least some of which have been ionised to the carboxylate state (—COO⁻). Within this context, block A is advantageously a polyacrylate or poly(acrylic acid) block or alternatively a poly(styrene sulfonate) block, a poly(vinylphosphonic acid) block or a poly(acrylamidomethylpropanesulfonic acid) block.

In the most general case, irrespective of the nature of the mineral particles and their surface charge, it can prove advantageous for the hydrophilic block A of the polymers P to comprise, in addition to the groups R^{A}, hydrophilic units obtained from the incorporation of hydrophilic monomers into the block A. “Hydrophilic monomer” is here understood as being monomers whose solubility in water is greater than 52 g/l at 20° C. under a pressure of 1 bar. Examples of such hydrophilic monomers which may be mentioned include especially hydroxyethyl acrylates, hydroxyethyl methacrylates, acrylamide, N-vinylpyrrolidone, or macromonomers such as the acrylates or methacrylates of ethylene and/or propylene polyoxide, or polyvinyl alcohol.

Moreover, independently of the nature of block A and of the groups R^{A}, the block(s) B in polymers P are blocks having an affinity in respect of the organic dispersing medium. Within the scope of the present description, “block B having an affinity in respect of the dispersing medium” is understood as being a block that is soluble in the dispersing medium when in the isolated state (that is to say in the form of a polymer B isolated from block A of the polymer P).

In order to choose a block B that is suited to a particular dispersing medium it will accordingly be possible to choose a block whose solubility parameters are compatible with those of the dispersing medium. “Solubility parameters” are here to be understood as being the parameters as defined especially in the work “Handbook of solubility parameters and other cohesion parameters” by Allan FM BARTON, CRC Press, Boca Raton (Fla.), ISBN 0-8493-3295-8. Reference can also be made to that work in respect of the calculation of the solubility parameters and their use to determine the compatibility of a solute such as a polymer in a given solvent.

Table I below shows, by way of information, examples of polymer blocks which can be used as block B for solvents of different polarities. The examples given in this table are given only by way of information, and the invention is, of course, not limited to these specific examples of pairs (block B/dispersing medium).

TABLE I
Examples of blocks B suitable for
some particular dispersing media

| Dispersing medium used | Example of suitable block B |
|---|---|
| Butyl acetate | Poly(2-ethylhexyl acrylate) |
| | Poly(isooctyl acrylate) |
| | Poly(butyl acrylate) |
| | Random polymer⁽¹⁾ |
| | (butyl acrylate/2- |
| | hydroxyethyl acrylate) |
| Exxsol D40 | Poly(2-ethylhexyl acrylate) |
| | Poly(isooctyl acrylate) |
| | Poly(butyl acrylate) |
| | Random polymer⁽²⁾ |
| | butyl acrylate/2- |
| | hydroxyethyl acrylate |
| Isopar L | Poly(2-ethylhexyl acrylate) |
| Mixture of methyl methacrylate and 2- | Poly(2-ethylhexyl acrylate) |
| ethylhexyl acrylate (50/50 by weight) | |
| Cyclomethicone | Poly(dimethylsiloxane) |

⁽¹⁾a suitable block polymer comprises, for example, from 10% to 30% by weight of 2-hydroxyethyl acrylate (especially 13% or 26% by weight).
⁽²⁾a suitable block polymer comprises, for example, from 10 to 20% by weight of 2-hydroxyethyl acrylate (especially 13% by weight).

The polymers P used as stabilising agents in the organosol of the present invention can have different structures, independently of the exact chemical nature of their blocks A and B.

Accordingly, according to a first variant, the polymers P used as agents for stabilising the dispersion comprise (or even are substantially) diblock polymers constituted by an association of the hydrophilic block A and the hydrophobic block B, that is to say polymers of the schematic formula A-B.

According to another variant, the polymers P used as agents for stabilising the dispersion comprise (or are substantially) copolymers having a plurality of hydrophobic blocks (B1, B2, . . . BN, where N can range from 2 to 100) covalently bonded to the hydrophilic block A. The copolymers according to this variant based on a plurality of hydrophobic blocks advantageously comprise (and preferably are):
block polymers of the triblock type of the formula B1-A-B2, wherein each of the groups B1 and B2 represents a hydrophobic block of type B mentioned above; and/or
comb-type polymers in which a plurality of hydrophobic blocks of type B mentioned above are bonded, as side chains, to the hydrophilic block A. Typically, such comb-type polymers have the following schematic formula:

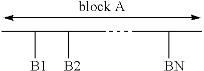

Irrespective of the exact structure of the polymer P, it is more often than not advantageous for the polymers P statistically to comprise an average number of groups R^{A} greater than 1 within block A, the average number of groups R^{A} within block A preferably being at least equal to 2, for example from 2 to 4, the average number generally being less than 7, advantageously less than or equal to 5. The inventors' works have in fact shown that, the greater the number of groups R^{A} in block A, the more the stabilising effect increases. Without wishing to be bound to any theory, it appears that increasing the number of groups R^{A} in block A leads to a multiplication of the probabilities of bonding between the particles and the polymers P, which leads to an increase in the binding between the two species, which is not observed with conventional surface-active agents of the oleic acid or isostearic acid type.

In addition, especially in order to limit the viscosity of the sol and avoid too high a mass content of polymer P in the organosol, it is generally preferred for the polymer P that is used to have a molecular mass of less than 10,000 g/mol, the molecular mass being preferably less than 5000 g/mol and advantageously less than or equal to 3000 g/mol. Nevertheless, the polymers used generally have a molecular mass greater than that of the surface-active agents conventionally used for the stabilisation of organosols. Accordingly, the molecular mass of the polymers P used according to the invention is preferably greater than or equal to 1000 g/mol, and it is advantageously from 1000 to 3000 g/mol, for example from 1500 to 2500 g/mol.

Moreover, in the polymers P, the mass ratio (hydrophilic block A/block(s) B) is advantageously from 0.02 to 0.5. That ratio corresponds generally to the ratio known as the “hydrophilic/lipophilic balance” (“HLB” ratio) of the polymer. The mass ratio (hydrophilic block A/block(s) B) to be employed depends substantially on the concentration of particles in the dispersion and on the dispersing nature, and its optimal value is accordingly to be adapted from one case to another. Nevertheless, in the majority of cases, good stabilisation properties are obtained for mass ratios (hydrophilic block A/block(s) B) in the polymers P of from 0.02 to 0.5 and, in particular, when the ratio is from 0.05 to 0.2.

In addition, in a polymer P used according to the invention, the molecular mass of block A is preferably from 50 to 5000 g/mol, more advantageously from 100 to 1000 g/mol. The molecular mass of each of the hydrophobic groups B present in the polymers P is generally greater than that of block A, that molecular mass advantageously being from 500 to 8000 g/mol, for example from 1000 to 4000 g/mol.

In the most general case, irrespective of the nature and structure of the polymers P and of the particles that are present, the mass ratio (particles/polymer) within a dispersion according to the invention is preferably greater than or equal to 0.1, preferably greater than or equal to 0.2. Typically, the mass ratio (particles/polymer) within the dispersion is from 0.2 to 0.6, for example from 0.2 to 0.5.

In addition, it is generally preferred for the molar ratio (groups R^{A} of the hydrophilic block A/mineral constituent of the particles) to be greater than or equal to 0.2, preferably greater than or equal to 0.3, that ratio advantageously being from 0.3 to 1 and typically from 0.4 to 0.8, advantageously from 0.4 to 0.6.

Moreover, it is often advantageous for the mass ratio (polymers/solvent) in a dispersion according to the invention to be greater than or equal to 0.005, preferably at least 0.02, which allows pronounced stabilising effects to be obtained. However, in order especially to avoid too great an increase in the viscosity of the suspension, it is preferred for that ratio to remain below 0.7, preferably below 0.5.

As polymers P that are especially suitable within the scope of the present invention there may be used especially block polymers as obtained especially according to the controlled (living) free-radical polymerisation processes described, for example, in patent applications WO 98/58974, WO 00/75207 and WO 01/4231.

By carrying out living free-radical polymerisation processes it is possible to obtain polymers P having a particularly well defined structure and size, the functionality of which and the properties of each of the blocks can be very finely controlled and modulated. Among other advantages, those processes accordingly permit the obtainment of polymers P carrying reactive functions (for example OH groups), which makes it possible to obtain stabilised organosols according to the invention in which the polymers are not confined to acting as stabilising agents but can provide other effects. Moreover, the implementation of the processes of patent applications WO 98/58974, WO 00/75207 and WO 01/4231 permits in this context the polymerisation of ionic monomers and monomers carrying anionic or cationic groups under gentle conditions, without the need for the ionic groups to be protected.

Particularly valuable block polymers P are those which are obtainable according to a process of controlled free-radical polymerisation comprising the following successive steps:

(e1) a first polymer block functionalised at the chain end is formed by bringing into contact:
at least one ethylenically unsaturated monomer,
at least one free radical source, and
at least one xanthate, dithioester, thioether-thione, dithiocarbazate or dithiocarbamate, preferably xanthate, and advantageously a compound of the type described in application WO 01/4231; and then
   (e2) a second block is formed on the first polymer block functionalised at the chain end obtained in step (e1), by reacting the resulting polymer with a new ethylenically unsaturated monomer and a free radical source.

That preparation process can advantageously be used for the synthesis of block polymers P of the diblock type.

Within this context, according to a first embodiment, there is formed in step (e1) the hydrophilic block of the diblock polymer (for example a poly(acrylic acid) block) and, in step (e2), a second block, this time of hydrophobic nature, is grown on the hydrophilic block obtained.

Conversely, according to another embodiment, the hydrophobic block of the diblock polymer (for example a poly(acrylic acid) block) can be formed in step (e1). In this case, step (e2) is conducted in such a manner as to grow on the resulting hydrophobic block a second block of hydrophilic nature.

It is to be emphasised that, for a diblock polymer of given composition, those two preparation methods are not equivalent and in practice yield polymers that often exhibit different organosol-stabilising properties, in particular when the hydrophilic block is of very small size. It is often found to be preferable to carry out the synthesis of the hydrophilic block first in step (e1), followed by synthesis of the hydrophobic block in step (e2).

According to another particular embodiment, step (e2) can be carried out twice in succession in order to synthesise polymers (P) of the triblock type. In this case, a first hydrophobic block is generally synthesised in step (e1), and a hydrophilic block is grown on that block, and then a new hydrophobic block is grown at the end of the hydrophilic block so obtained.

Within the scope of the present invention it is generally preferable to carry out steps (e1) and (e2) using compounds of the xanthate type, preferably xanthates carrying O-ethyl or O-trifluoroethyl groups. In addition, steps (e1) and (e2) are advantageously carried out in solution.

When the particles of the dispersion of the invention have a negative surface charge (silica-based particles, for example), it is accordingly possible to use as polymers P polymers obtained in the processes described hereinbefore and carrying cationic groups (quaternary ammonium) on their hydrophilic block, such as block polymers of the type poly(butyl acrylate)-poly(quaternised 2-dimethylaminoethyl acrylate); poly(2-ethylhexyl acrylate)-poly(quaternised 2-dimethylaminoethyl acrylate); or poly(2-ethylhexyl acrylate)-poly(quaternised p-chloromethylstyrene).

Conversely, when the particles of the dispersion of the invention have a positive surface charge (CeO₂- or TiO₂-based particles, for example), it is possible to use as polymers P especially polymers obtained in the preceding processes and carrying anionic groups (for example carboxylates, sulfates or sulfonates) on their hydrophilic block, such as block polymers of the type poly(butyl acrylate)-poly(acrylic acid); poly(2-ethylhexyl acrylate)-poly(acrylic acid); poly(2-ethylhexyl acrylate)-poly(styrenesulfonate); poly(butyl acrylate)-poly(styrenesulfonate); poly(isooctyl acrylate)-poly(acrylic acid); or poly(2-ethylhexyl acrylate)-poly(vinylphosphonic acid).

When the particles of the dispersion of the invention have a positive surface charge, and very particularly when they are particles based on cerium oxide, it is found to be advantageous to use as polymers P poly(acrylic acid)-poly(2-ethylhexyl acrylate) polymers (referred to here as PAA-P2EHA), and advantageously polymers of that type having a molar mass of from 1500 to 4000 g/mol and wherein the mass ratio (PAA/P2EHA) is preferably from 0.02 to 0.5 (advantageously from 0.05 to 0.2).

The inventors have in fact demonstrated that those particular PAA-P2EHA copolymers prove to be suitable for stabilising the dispersion of particles having a positive surface charge (for example CeO₂ particles) in the majority of the organic dispersing media used in the field of organosols. In other words, the above-mentioned PAA-P2EHA polymers constitute, as it were, a “universal stabiliser” for the dispersion of particles of the type particles based on cerium oxide in the majority of organic solvents usable as dispersing media.

Advantageously, the PAA-P2EHA polymers used within this context comprise a polyacrylic acid (PAA) hydrophilic block having a molecular mass of the order of from 125 to 150 g/mol and a poly(2-ethylhexyl acrylate) (P2EHA) hydrophobic block having a molecular mass of the order of from 1000 to 9000 g/mol (for example of the order of 2250 g/mol).

According to a specific aspect, the above-mentioned PAA-P2EHA polymers constitute a particular object of the present invention.

According to another aspect, the present invention relates also to the preparation of the organosols described hereinbefore.

Within this context, the invention first provides, according to a first particular aspect, a process which permits the preparation of dispersions of the above-mentioned type wherein the organic dispersing medium is specifically of a hydrophobic nature. That process comprises a step (A) which comprises bringing an aqueous suspension of the particles into contact with said organic medium, in the presence of the amphiphilic block polymers P as defined hereinbefore, as a result of which the particles are transferred from the aqueous phase to the hydrophobic solvent medium in the form of an organic suspension stabilised by the polymers.

In general, step (A) is followed by recovery of the organic phase which constitutes the desired dispersion (organosol).

In the most general case, step (A) is in fact analogous to the phase transfer processes conventionally used to prepare organosols stabilised by surfactants, for example of the oleic acid or isostearic acid type, such as those described, for example, in patent application FR 2 721 615 or in the article by Meriguet et al. in Journal of Colloid and Interface Science, 267, pp. 78-85 (2003). As a general rule, the conditions defined for the use of surface-active agents can be directly transposed to the use of polymers P employed according to the present invention.

More specifically, within the scope of the present invention, the initial aqueous suspension used in step (A) advantageously has a concentration of mineral particles of from 1 to 100 g/l. In terms of phase transfer, step (A) is more often than not found to be more effective, the lower that concentration. Accordingly, it is generally preferred to use a concentration of mineral particles of less than or equal to 75 g/l, for example less than or equal to 50 g/l, more preferably less than or equal to 40 g/l and even more advantageously less than 20 g/l, in the initial aqueous suspension of step (A). However, especially from an economic point of view and in terms of effluent treatment, it is more often than not desirable for the concentration to be at least 2 g/l, preferably at least 3 g/l and more preferably at least 5 g/l. Accordingly, the concentration is typically from 2 to 75 g/l, advantageously from 3 to 50 g/l and typically of the order of from 5 to 30 g/l, for example of the order of 20 g/l.

The aqueous suspension initially used in step (A) contains particles in the dispersed state which, at least for the most part, will be found in the dispersed state in the organic phase, following step (A). The aqueous dispersions used in this context advantageously comprise particles having a low hydrodynamic diameter within the aqueous dispersion, for example an average hydrodynamic diameter of from 1 to 200 nm, the hydrodynamic diameter preferably being less than 70 nm and more advantageously less than or equal to 50 nm. The “average hydrodynamic diameter” of the particles to which reference is made here is that determined in accordance with the quasi-elastic light scattering method, as described especially in Analytical Chemistry, Vol. 53, no. 8, 1007 A, (1981). Typically, the average hydrodynamic diameter of the particles in the initial aqueous dispersion of step (A) is from 1 to 70 nm, for example from 2 to 60 nm, especially from 3 to 50 nm.

The process of the invention allows to provide organosols from aqueous dispersions of particles having very small dimensions, for example having an average hydrodynamic diameter of less than or equal to 50 nm, or even less than or equal to 20 nm, or even less than or equal to 10 nm, for example of the order of several nanometres. Within this context, taking into account the specificity of the process and the use of the polymers P, the process of the invention more often than not yields organosols wherein the size of the dispersed mineral objects (size measurable by electron microscopy of the organosol, without taking into account the organic layer surrounding the mineral objects) is of the order of magnitude of the hydrodynamic diameter of the particles dispersed in the initial aqueous suspension. Accordingly, starting from aqueous sols of particles of small dimensions, there are obtained according to the process of the invention organosols based on dispersed mineral objects that are likewise of small size. Conversely, it is possible, if desired, to obtain dispersed objects of a larger size in the final organosol by using in step (A) an aqueous suspension wherein the average hydrodynamic diameter of the particles is greater.

In addition, it is preferred to use in step (A) aqueous suspensions wherein the particles have a specific BET surface area of from 5 to 500 m²/g, preferably of at least 50 m²/g, and more preferably of at least 100 m²/g, for example of at least 200 m²/g and especially of at least 250 m²/g, for which good effectiveness of the transfer from the aqueous medium to the organic medium is obtained. “Specific BET surface area” is here understood as meaning the specific surface area as determined by nitrogen adsorption in accordance with standard ASTMD 3663-78 established according to the BRUNAUER-EMMETT-TELLER method described in “The Journal of the American Society”, 60, 309 (1938). In order to measure the specific surface area of the particles according to the invention, when they are in the form of a dispersion, the measuring protocol comprises removing the liquid phase from the dispersion and then drying the particles in vacuo at a temperature of 150° C. for at least 4 hours.

The process of the invention is based on the transfer of the particles from the aqueous medium to the organic medium. It is to be noted in this connection that, in addition to their properties of stabilising the final organosol while maintaining a good state of dispersion of the mineral objects, the block copolymers P as used according to the invention also enable the transfer of the particles to be carried out with considerable effectiveness and with a high yield. Accordingly, within the scope of the process of the invention, the yields obtained in respect of the transfer of particles from the aqueous medium to the organic medium are at least 80% and more often than not at least 90% or even at least 95%.

In order to optimise the effectiveness of this transfer and obtain high yields, it is also possible especially to influence the following different parameters of the process:

the average number of groups R^{A} within block A of the polymers P:

within this context, the inventors' works have shown that the yield of the phase transfer is higher, the greater the average number of groups R^{A} within block A. In order to obtain good yields, the average number is preferably at least 2 and advantageously at least 3.

the molecular mass of the polymers P:

the transfer yield generally tends to fall when the mass increases, especially on account of diffusion problems which are observed with the polymers when their size increases. In order to obtain transfer yields that are of value, it is more often than not appropriate to use polymers having a molecular mass of less than 10,000 g/mol, preferably less than 5000 g/mol and advantageously less than or equal to 3000 g/mol, for example from 1000 to 3000 g/mol and typically from 1500 to 2500 g/mol.

the mass ratio (hydrophilic block A/block(s) B) in the polymers P:

in the majority of cases, good transfers are obtained with a mass ratio (hydrophilic block A/block(s) B) of from 0.02 to 0.5, and in particular when the ratio is from 0.05 to 2.

Besides, the inventors have demonstrated that the dispersions of the invention have an unexpected specific property, further to their stability. More precisely, it is found that, in view of the specific use of the polymers P, if the dispersing medium is removed from a dispersion according to the invention, especially by evaporation, there is obtained a mixture that is constituted substantially by the particles and the polymers and that has the surprising capacity of being able to be redispersed in a dispersing medium to form a stabilised dispersion of the organosol type again (on condition, however, that the new dispersing medium is compatible with the blocks B of the polymers P used). This property of the organosols of the invention is wholly surprising in view of the results obtained with the stabilising agents of the surfactant type (especially oleic acid or isostearic acid), with which evaporation of the dispersing medium results, by contrast, in irreversible aggregation of the particles.

The present invention relates also to compositions of the type obtained by removal of the organic medium present in an organosol according to the invention, which compositions comprise mineral particles and polymers P of the above-mentioned type and are dispersible in an organic medium to form a new stabilised dispersion of mineral particles. Such redispersible compositions are more often than not in the form of oily compositions. Most frequently, such compositions are constituted substantially of a mixture of organic particles and amphiphilic block polymers.

The process for the preparation of the above-mentioned redispersible compositions, by removal of the organic medium present in a dispersion of mineral particles according to the invention, especially by evaporation of the organic medium, constitutes another particular object of the present invention.

For the preparation of redispersible dispersions of the above-mentioned type based on particles and polymers P, it is advantageously possible to form an organosol according to step (A) mentioned above, using specifically as dispersing medium a hydrophobic organic solvent having a low boiling point, such as, for example, toluene. The use of such a volatile dispersing medium permits facilitates its subsequent removal, which can be effected simply by evaporating off the volatile solvent to give the desired redispersible compositions directly.

Irrespective of the method used to obtain them, the redispersible compositions of the invention can be used in the preparation of dispersions of particles in any organic medium, including organic media that are not compatible with the implementation of step (A), such as hydrophilic organic media.

Within this context, the invention thus provides, according to a further aspect, a process for the preparation of a dispersion of such mineral particles, in which the organic medium can be either hydrophobic or hydrophilic, the process comprising a step (B) in which a redispersible composition of the above-mentioned type is dispersed in said hydrophobic or hydrophilic organic medium.

According to a specific embodiment, the invention accordingly provides in particular a process for the preparation of a dispersion of mineral particles in a hydrophilic organic dispersing medium, which process comprises:

carrying out step (A) mentioned above using a first dispersing medium that preferably has a low boiling point, and then

removing said first dispersing medium (for example by evaporation) to yield a redispersible composition of the above-mentioned type; and then

carrying out step (B) mentioned above using said hydrophilic organic dispersing medium as dispersing medium.

Irrespective of the method by which they are prepared, the organosols of the invention can be used in a large number of technical fields.

In particular, the organosols are found to be particularly suitable for the preparation of solvent-containing compositions, such as, especially, paints.

Some of the organosols of the invention can also be used in the formulation of compositions in the field of cosmetics, on condition that cosmetically acceptable particles are used. In this type of application, the organic dispersing medium of the organosol is preferably of the vegetable oil, silicone oil and/or mineral oil type.

According to a particular embodiment, the organosols of the invention can also be used to carry out catalysed reactions in a solvent medium (in this case the particles used are particles having catalytic properties, generally particles having at the surface catalytically active species which have been deposited on the particles or form part of the structure of the particle).

According to another aspect, these various uses constitute another particular object of the present invention.

Various advantages and valuable features of the invention will become more apparent from the illustrative examples described hereinafter.

### EXAMPLES

### A—Preparation of Amphiphilic Block Polymers According to the Invention

### Example A1

### Synthesis of a Block Copolymer of the PEHA-PAA Type (Theoretical Molecular Mass of the poly(2-ethylhexyl acrylate) Block: 2250 Theoretical Molecular Mass of the poly(acrylic acid) Block: 125)

Step 1: Synthesis of a PEHA Block Having a Reactive End Group (Xanthate)

237.8 g of ethanol, 37.03 g of O-ethyl-S-(1-methoxycarbonyl)ethyl) xanthate (CH₃CHCO₂CH₃)S(C═S)OEt and 400 g of 2-ethylhexyl acrylate were introduced into a 2-litre glass reactor, maintained under argon, equipped with an impeller-type stirrer and a cooling apparatus.

The resulting mixture was heated to 75° C., and 4.52 g of azo-bis(methylisobutyronitrile) (AMBN) were added to the reaction mixture, and then the reaction was allowed to continue for 9 hours at 75° C.

Analyses by ¹H NMR and gas chromatography indicate that the acrylate monomer has been polymerised completely. The molar mass of the resulting polymer, as measured by steric exclusion chromatography (calibration by polystyrene) is 2350 g/mol.

Step 2: Synthesis of the Diblock Polymer PAA-PEHA

0.11 g of AMBN, diluted in 1 g of ethanol, was added to the mixture obtained in the first step, maintained at 75° C. Immediately thereafter, a solution of 22.2 g of acrylic acid in 15 g of ethanol was introduced into the mixture in a single portion. The mixture so obtained was allowed to react for 2 hours at 75° C., and then 0.11 g of AMBN, diluted in 1 g of ethanol, was added. Following this further addition of AMBN, the reaction mixture was maintained at 75° C. for 8 hours.

This reaction yielded a diblock polymer PAA-PEHA. ¹H NMR analysis indicates that the composition of the final copolymer corresponds to the expected composition. HPLC analysis indicates that all the acrylic acid introduced has been consumed.

### Example A2

### Synthesis of a Block Copolymer of the PAA-PEHA Type (Theoretical Molecular Mass of the poly(2-ethylhexyl acrylate) Block: 2250 Theoretical Molecular Mass of the poly(acrylic acid) Block: 125)

Step 1: Synthesis of a PAA Block Having a Reactive End Group (Xanthate)

28.8 g of ethanol, 33.32 g of O-ethyl-S-(1-methoxycarbonyl)ethyl)xanthate (CH₃CHCO₂CH₃)S(C═S)OEt and 20 g of acrylic acid were introduced into a 2-litre glass reactor, maintained under argon, equipped with an impeller-type stirrer and a cooling apparatus. The solution was heated to 75° C., and 0.3 g of azo-bis(methylisobutyronitrile) (AMBN) were added to the reaction mixture. The resulting reaction mixture was then maintained at 75° C. for 9 hours.

Analyses by ¹H NMR and gas chromatography indicate that the monomer has been polymerised completely. The molar mass of the resulting polymer, as measured by steric exclusion chromatography (calibration by polyethylene oxide) is 400 g/mol.

Step 2: Synthesis of the Diblock Polymer PAA-PEHA

1.8 g of AMBN, diluted in 1 g of ethanol, were added to the mixture obtained in the first step, maintained at 75° C. Immediately thereafter, a solution of 360 g of 2-ethylhexyl acrylate in 242.4 g of ethanol was introduced into the mixture in a single portion, and then the mixture was allowed to react for 2 hours after introduction of the acrylate solution.

1.8 g of AMBN, diluted in 1 g of ethanol, were then introduced. Following this further addition of AMBN, the reaction mixture was maintained at 75° C. for 8 hours.

This reaction yielded the desired diblock polymer PAA-PEHA. ¹H NMR analysis indicates that the composition of the final copolymer corresponds to the expected composition. Analysis by gas chromatography indicates that all the 2-ethylhexyl acrylate has been consumed.

### Example A3

### Synthesis of a Block Copolymer of the PAA-PEHA Type (Theoretical Molecular Mass of the poly(2-ethylhexyl acrylate) Block: 1125 Theoretical Molecular Mass of the poly(acrylic acid) Block: 250)

Step 1: Synthesis of a PAA Block Having a Reactive End Group (Xanthate)

20.4 g of ethanol, 16.66 g of O-ethyl-S-(1-methoxycarbonyl)ethyl)xanthate (CH₃CHCO₂CH₃)S(C═S)OEt and 20 g of acrylic acid were introduced into a 2-litre glass reactor, maintained under argon, equipped with an impeller-type stirrer and a cooling apparatus.

The resulting mixture was heated to 75° C., and 1.17 g of azo-bis(methylisobutyronitrile) (AMBN) were added to the reaction mixture, and then the reaction was allowed to continue for 9 hours at 75° C.

Analyses by ¹H NMR and gas chromatography indicate that the acrylic acid monomer has been polymerised completely. The molar mass of the resulting polymer, as measured by steric exclusion chromatography, is 550 g/mol.

Step 2: Synthesis of the Diblock Polymer PAA-PEHA

0.45 g of AMBN, diluted in 1 g of ethanol, was added to the mixture obtained in the first step, maintained at 75° C. Immediately thereafter, a solution of 60 g of 2-ethylhexyl acrylate in 60.6 g of ethanol was introduced into the mixture in a single portion. The mixture so obtained was allowed to react for 2 hours at 75° C., and then 0.45 g of AMBN, diluted in 1 g of ethanol, was added. Following this further addition of AMBN, the reaction mixture was maintained at 75° C. for 8 hours.

This reaction yielded a diblock polymer PAA-PEHA. ¹H NMR analysis indicates that the composition of the final copolymer corresponds to the expected composition. Analysis by gas chromatography indicates that all the 2-ethylhexyl acrylate has been consumed.

### Example A4

### Synthesis of a Block Copolymer of the PEHA-PAA Type (Theoretical Molecular Mass of the poly(acrylic acid) Block: 250 Theoretical Molecular Mass of the poly(2-ethylhexyl acrylate) block: 4500)

Step 1: Synthesis of a PEHA Block Having a Reactive End Group (Xanthate)

227.7 g of ethanol, 18.51 g of O-ethyl-S-(1-methoxycarbonyl)ethyl)xanthate (CH₃CHCO₂CH₃)S(C═S)OEt and 400 g of 2-ethylhexyl acrylate were introduced into a 2-litre glass reactor, maintained under argon, equipped with an impeller-type stirrer and a cooling apparatus.

The resulting mixture was heated to 75° C., and 4.52 g of azo-bis(methylisobutyronitrile) (AMBN) were added to the reaction mixture, and then the reaction was allowed to continue for 9 hours at 75° C.

Analyses by ¹H NMR and gas chromatography indicate that the acrylate monomer has been polymerised completely. The molar mass of the resulting polymer, as measured by steric exclusion chromatography, is 4300 g/mol.

Step 2: Synthesis of the Diblock Polymer PAA-PEHA

0.11 g of AMBN, diluted in 1 g of ethanol, was added to the mixture obtained in the first step, maintained at 75° C. A solution of 22.2 g of acrylic acid in 15 g of ethanol was introduced into the mixture in a single portion. The mixture so obtained was allowed to react for 2 hours at 75° C., and then 0.11 g of AMBN, diluted in 1 g of ethanol, was added. Following this further addition of AMBN, the reaction mixture was maintained at 75° C. for 8 hours.

This reaction yielded a diblock polymer PAA-PEHA. ¹H NMR analysis indicates that the composition of the final copolymer corresponds to the expected composition. Analysis by gas chromatography indicates that all the acrylic acid has been consumed.

### Example A5

### Synthesis of a Block Copolymer of the PAA-PEHA Type (Theoretical Molecular Mass of the poly(2-ethylhexyl acrylate) Block: 1125 Theoretical Molecular Mass of the poly(acrylic acid) Block: 250)

Step 1: Synthesis of a PEHA Block Having a Reactive End Group (Xanthate)

135.5 g of ethanol, 38.9 g of O-ethyl-S-(1-methoxycarbonyl)ethyl)xanthate (CH₃CHCO₂CH₃)S(C═S)OEt and 210 g of 2-ethylhexyl acrylate were introduced into a 2-litre glass reactor, maintained under argon, equipped with an impeller-type stirrer and a cooling apparatus.

The resulting mixture was heated to 75° C., and 2.75 g of azo-bis(methylisobutyronitrile) (AMBN) are added to the reaction mixture, and then the reaction was allowed to continue for 9 hours at 75° C.

Analyses by ¹H NMR and gas chromatography indicate that the monomer has been polymerised completely. The molar mass of the resulting polymer, as measured by steric exclusion chromatography, is 1300 g/mol.

Step 2: Synthesis of the Diblock Polymer PAA-PEHA

0.23 g of AMBN, diluted in 1 g of ethanol, was added to the mixture obtained in the first step, maintained at 75° C. Immediately thereafter, a solution of 46.67 g of acrylic acid in 31.4 g of ethanol was introduced into the mixture in a single portion. The mixture so obtained was allowed to react for 2 hours at 75° C., and then 0.23 g of AMBN, diluted in 1 g of ethanol, was added. Following this further addition of AMBN, the reaction mixture was maintained at 75° C. for 8 hours.

This reaction yielded a diblock polymer PAA-PEHA. ¹H NMR analysis indicates that the composition of the final copolymer corresponds to the expected composition. HPLC analysis indicates that all the acrylic acid introduced has been consumed.

### Example A6

### Synthesis of a Diblock Copolymer of the PIO-PAA Type (poly(isooctyl acrylate)-poly(acrylic acid)) (Theoretical Molecular Mass of the poly(isooctyl acrylate) Block: 2250 Theoretical Molecular Mass of the poly(acrylic acid) Block: 125)

Step 1: Synthesis of a PAI Block Having a Reactive End Group (Xanthate)

18.7 g of ethanol, 4.7 g of tetrahydrofuran, 3.34 g of O-ethyl-S-(1-methoxycarbonyl)ethyl)xanthate (CH₃CHCO₂CH₃)S(C═S)OEt and 36 g of isooctyl acrylate were introduced into a 100 ml two-necked glass flask, maintained under argon, equipped with a magnetic stirrer and a cooling apparatus.

The resulting mixture was heated to a temperature of 75° C., and 3.3 g of azo-bis(methylisobutyronitrile) (AMBN) are added to the reaction mixture, and then the reaction mixture was maintained at 75° C. for 9 hours.

Analyses by ¹H NMR and gas chromatography indicate that the monomer has been polymerised completely. The molar mass of the resulting polymer, as measured by steric exclusion chromatography, is 2400 g/mol.

Step 2: Synthesis of the Diblock Polymer PAI-PAA

0.8 g of AMBN, diluted in 1 g of ethanol, was added to the mixture obtained in the first step, maintained at 75° C. Immediately thereafter, a solution of 4 g of acrylic acid and 3.3 g of ethanol was introduced into the mixture in a single portion. The mixture was then allowed to react for 3 hours, and then 0.8 g of AMBN, diluted in 1 g of ethanol, was added. Following this further addition of AMBN, the reaction mixture was maintained at 75° C. for 6 hours.

This reaction yielded a diblock polymer PAI-PAA. ¹H NMR analysis indicates that the composition of the final copolymer corresponds to the expected composition. Analysis by HPLC chromatography indicates that all the acrylic acid has been consumed.

### Example A7

### Synthesis of a Diblock Copolymer of the PAB-PAA Type (poly(butyl acrylate)-poly(acrylic acid)) (Theoretical Molecular Mass of the poly(butyl acrylate) Block: 2250 Theoretical Molecular Mass of the poly(acrylic acid) Block: 125)

Step 1: Synthesis of a PAB Block Having a Reactive End Group (Xanthate)

83 g of ethanol, 12.94 g of O-ethyl-S-(1-methoxycarbonyl)ethyl)xanthate (CH₃CHCO₂CH₃)S(C═S)OEt and 140 g of butyl acrylate were introduced into a 500 ml two-necked glass flask, maintained under argon, equipped with a magnetic stirrer and a cooling apparatus.

The mixture so obtained was heated to 75° C., and 1.5 g of azo-bis(methyl-isobutyronitrile) (AMBN) were added to the reaction mixture, and then the resulting mixture was maintained at 75° C. for 9 hours.

Analyses by ¹H NMR and gas chromatography indicate that the monomer has been polymerised completely. The molar mass of the resulting polymer, as measured by steric exclusion chromatography, is 2150 g/mol.

Step 2: Synthesis of the Diblock Polymer PAB-PAA

A solution of 36 g of polymer obtained in the first step in 29.4 g of ethanol was placed in a 100 ml glass reactor maintained at 75° C., and then 5 mg of AMBN were introduced into the mixture. Immediately thereafter, a solution of 2 g of acrylic acid in 1.95 g of ethanol was introduced into the reaction mixture in a single portion.

The resulting mixture was allowed to react for 3 hours after introduction of the acrylic acid solution, and then 5 mg of AMBN were added. Following this further addition of AMBN, the reaction mixture was maintained at 75° C. for 6 hours.

This reaction yielded a diblock polymer PAB-PAA. ¹H NMR analysis indicates that the composition of the final copolymer corresponds to the expected composition. Analysis by HPLC chromatography indicates that all the acrylic acid has been consumed.

### Example A8

### Synthesis of a Diblock Copolymer of the Random Copolymer Type (2-ethylhexyl acrylate/2-hydroxyethyl acrylate)-poly(acrylic acid) (Theoretical Molecular Mass of the Random Copolymer Block: 2250 Theoretical Molecular Mass of the poly(acrylic acid) Block: 125)

Step 1: Synthesis of a Random Copolymer Block (2-ethylhexyl acrylate/2-hydroxyethyl acrylate) Having a Reactive End Group (Xanthate)

38.7 g of ethanol, 6.26 g of O-ethyl-S-(1-methoxycarbonyl)ethyl)xanthate (CH₃CHCO₂CH₃)S(C═S)OEt, 47.8 g of 2-ethylhexyl acrylate and 17.16 g of 2-hydroxyethyl acrylate were introduced into a 100 ml glass flask, maintained under argon, equipped with a magnetic stirrer and a cooling apparatus.

The resulting mixture was heated to 75° C., 0.7 g of azo-bis(methylisobutyronitrile) (AMBN) were added to the reaction mixture, and then the mixture was allowed to react for 9 hours at 75° C.

Analyses by ¹H NMR and gas chromatography indicate that the monomers introduced have polymerised completely. The molar mass of the resulting polymer, as measured by steric exclusion chromatography, is 2350 g/mol (with a M_{w}/Mₙ ratio of 1.60).

Step 2: Synthesis of the Diblock Polymer

0.015 g of AMBN, diluted in 1 g of ethanol, was added to the mixture obtained in the first step, maintained at 75° C. Immediately thereafter, a mixture containing 3 g of acrylic acid and 2.92 g of ethanol was added to the mixture in a single portion.

The reaction mixture was then allowed to react for 3 hours after introduction of the acrylic acid solution, and then 0.015 g of AMBN, diluted in 1 g of ethanol, was added. Following this further addition of AMBN, the reaction was maintained at 75° C. for 8 hours.

This reaction yielded the desired diblock polymer.

### Example A9

### Synthesis of a Block Copolymer of the PAA-PEHA Type (Theoretical Molecular Mass of the poly(2-ethylhexyl acrylate) Block: 1125 Theoretical Molecular Mass of the poly(acrylic acid) Block: 125)

Step 1: Synthesis of a PEHA Block Having a Reactive End Group (Xanthate)

135.5 g of ethanol, 38.9 g of O-ethyl-S-(1-methoxycarbonyl)ethyl)xanthate (CH₃CHCO₂CH₃)S(C═S)OEt and 210 g of 2-ethylhexyl acrylate were introduced into a 2-litre glass reactor, maintained under argon, equipped with an impeller-type stirrer and a cooling apparatus.

The resulting mixture was heated to 75° C., and 2.50 g of azo-bis(methylisobutyronitrile) (AMBN) are added to the reaction mixture. The reaction mixture was then maintained at 75° C. for 9 hours.

Analyses by ¹H NMR and gas chromatography indicate that the monomer has been polymerised completely. The molar mass of the resulting polymer, as measured by steric exclusion chromatography, is 1200 g/mol.

Step 2: Synthesis of the Diblock Polymer PEHA-PAA

0.12 g of AMBN, diluted in 1 g of ethanol, is added to the polymer obtained in the first step, maintained at 75° C. Immediately thereafter, a mixture containing 23.33 g of acrylic acid and 15.71 g of ethanol is added in a single portion. 2 hours after introduction of the acrylic acid solution, 0.12 g of AMBN, diluted in 1 g of ethanol, is added. Following this further addition, the reaction is maintained at 75° C. for 8 hours.

¹H NMR analysis indicates that the composition of the final copolymer corresponds to the expected composition. Analysis by HPLC chromatography indicates that all the acrylic acid has been consumed.

### B—Preparation of Organosols According to the Invention Using the Polymers Synthesised Hereinbefore

### Example B1

### Organosol of CeO₂ Particles in Butyl Acetate Using the Block Polymer PAA-PEHA of Example A1 (Organosol O1)

Preparation of Organosol O1

Into a 2-litre reactor equipped with a cooling apparatus and an anchor-type mechanical stirrer there were introduced, with stirring, 200 ml of an aqueous sol of CeO₂ at 20 g/litre, having a hydrodynamic diameter of 5 nm, and then a solution of 33.47 g of the block copolymer PEHA-PAA of Example A1, and finally 200 ml of butyl acetate.

The relative quantities of polymer and of CeO₂ used in the mixture so prepared correspond to a molar ratio (COOH carried by the polymers/total CeO₂) of 1.

The mixture prepared was stirred at 60° C. for 6 hours in order to allow the transfer of particles from the aqueous sol to the organic phase to take place.

After stopping stirring and cooling the mixture to ambient temperature (approximately 25° C.), the resulting mixture was allowed to settle for one night (of the order of 12 hours).

After settling, the aqueous phase was separated from the organic phase by withdrawing the aqueous phase (which is more dense than the organic phase) through the valve at the bottom of the reactor. There was thus obtained an organosol O1 (separated organic phase).

The organosol O1 has a melting loss of 10.6% (calculated on the completely dried organosol), which corresponds to a rate of transfer of the particles from the initial aqueous sol to the organic medium of the order of 94.8%.

Stability of the Organosol O1

The resulting organosol has good stability. Accordingly, after storage of the organosol for 6 months at ambient temperature, no sedimentation of the particles is noted visually.

Possibility of “Drying” the Organosol O1 and Redispersing the Resulting Dried Composition in an Organic Medium

In order to illustrate the specific properties of the organosols of the invention, that is to say the possibility of removing their dispersing medium without affecting the dispersion of the mineral particles, the organosol O1 obtained previously was dried.

Within this context, the organosol was dried completely by evaporating off the butyl acetate in vacuo until a constant mass was achieved. There was thus obtained a pale yellow, transparent and viscous oil, composed substantially of CeO₂ particles and copolymer of Example A1.

The structure of the oil so obtained was analysed by small-angle X-ray scattering. The resulting spectrum shows a very intense peak at a wave-vector value q of 170 Å, which is characteristic of good dispersion of the mineral objects in the product. These results show that the resulting composition is a concentrated and ordered medium wherein the particles are regularly spaced within the polymer. Schematically, the particles are present in the composition in the form of substantially individual particles, despite the concentration of the medium, which appears to be attributable to the anchoring of the polymers to the particles by way of the acrylic acid functions carried by the polymers.

By way of comparison, drying of the initial aqueous sol was carried out, in the absence of block polymer, and the resulting dried powder was subjected to the same small-angle X-ray scattering analysis, yielding a radically different spectrum. Accordingly, instead of a peak of well defined order, there is observed a plateau with a not very pronounced maximum corresponding to a characteristic distance of the order of the average diameter of the particles (about 74 Å), with a rise of the curve at small angles, which reflects the phenomenon of agglomeration, which is not observed in the case of the dried organosol.

In addition, the dried organosol obtained after removal of the butyl acetate was again dispersed in butyl acetate at two different concentrations (0.5% and 1.6% by mass). The average hydrodynamic diameters of the objects dispersed in those organosols were measured by quasi-elastic light scattering, and the results obtained are indicated in Table II below.

TABLE 2
Sols obtained by redispersion of the organosol O1 after drying

| Concentration of CeO₂ | Hydrodynamic diameter of the objects |
|---|---|
| by mass | dispersed in the resulting organosol |
| 0.5% | from 12 to 18 nm |
| 1.6% | from 15 to 25 nm |

The measured hydrodynamic diameters indicate good redispersion of the CeO₂ in the solvent, in spite of the step of total drying to which the sol has been subjected. By way of information, the average hydrodynamic diameter of the objects dispersed in sol O1 before drying is of the order of 15 nm.

### Example B2

### Organosol of CeO₂ Particles in Butyl Acetate Using the Block Polymer PAA-PEHA of Example A2 (Organosol O2)

Into a 2-litre reactor equipped with a cooling apparatus and an anchor-type mechanical stirrer there were introduced 150 ml of an aqueous sol of CeO₂ at 20 g/litre, as used in Example B1, and there was then introduced into the reactor, with stirring, a solution of 9.55 g of the block copolymer PAA-PEHA of Example A2 in 150 ml of butyl acetate.

The relative quantities of polymer and of CeO₂ used in the mixture so prepared correspond to a molar ratio (COOH carried by the polymers/total CeO₂) of 0.4.

The mixture prepared was stirred at 60° C. for 6 hours. After stopping stirring and lowering the temperature to ambient temperature (approximately 25° C.), the mixture was allowed to settle for one night (of the order of 12 hours). After settling, the aqueous phase was separated from the organic phase by withdrawing the aqueous phase through the valve at the bottom of the reactor, as in Example B1.

There was thus obtained an organosol O₂ (separated organic phase) which, in the fully dried state, has a melting loss of 22.9%, which corresponds to a rate of transfer of 98.6%.

As in Example 1, the resulting organosol has good stability without resulting in sedimentation phenomena on storage.

### Example B3

### Organosol of CeO₂ Particles in Isopar L, Using the Block Polymer PAA-PEHA of Example A2 (Organosol O3)

Example B2 was repeated, except that the 150 ml of butyl acetate used were replaced by 150 ml of Isopar L.

There was thus obtained an organosol O3 of CeO₂ particles in Isopar L, with a rate of transfer of 96.1%.

Here too, the resulting organosol has good storage stability.

### Example B4

### Organosol of CeO₂ Particles in Exxsol D40, Using the Block Polymer PAA-PEHA of Example A2 (Organosol O4)

The protocol of Examples B2 and B3 was repeated, this time using 150 ml of Exxsol D40.

There was thus obtained an organosol O4 of CeO₂ particles in Exxsol D40, with a rate of transfer of 97.4%.

The results of Examples B2, B3 and B4 described above illustrate the suitability of the block polymers of the PAA-PEHA type for the preparation of organosols based on CeO₂ particles in many types of solvents having different polarities.

### Example B5

### Organosol of CeO₂ Particles in Butyl Acetate, Using the Block Polymer of Example A8 (Organosol O5)

Into a 2-litre reactor equipped with a cooling apparatus and an anchor-type mechanical stirrer there were introduced, with stirring, 150 ml of an aqueous sol of CeO₂ at 20 g/litre, as used in Example B1, and then a solution of 9.55 g of the copolymer of Example A8 in 150 ml of butyl acetate.

The relative quantities of polymer and of CeO₂ used in the mixture so prepared correspond to a molar ratio (COOH carried by the polymers/total CeO₂) of 0.4.

The mixture was stirred at 60° C. for 6 hours. After stopping stirring and lowering the temperature to ambient temperature (approximately 25° C.), the mixture was allowed to settle for one night (of the order of 12 hours). After settling, the aqueous phase was separated from the organic phase by withdrawing the aqueous phase through the valve at the bottom of the reactor.

A melting loss measured on the completely dried organosol permitted a rate of transfer of 94.1% to be estimated.

As in the preceding examples, the resulting organosol is stable to storage.

### Comparison Examples

### Comparison Example 1

### Comparison of the Stability of Organosols Obtained Using Block Copolymers According to the Invention and Using Conventional Surface-Active Agents

In order to demonstrate the significant improvement in the stability of the organosols that is achieved with the copolymers of the invention compared with the conventional surface-active agents, different organosols using those two types of stabilising agents were compared.

More precisely, a plurality of organosols of CeO₂ particles in Exxsol D40 were prepared using as stabilising agent a mixture M comprising block copolymer of Example A1 and/or isostearic acid, with variable proportions of copolymer and of isostearic acid, which are indicated in Table III below. In a particular case (control), the mixture M used contains 100% isostearic acid, without polymer. In the other cases, the mixture M comprises a polymer according to the invention in a proportion ranging from 10 to 100 mol. %.

In each case, the organosol was prepared according to the following protocol.

18 ml of aqueous CeO₂ sol at 5.77 g/litre were introduced into a 75 ml reactor equipped with a cooling apparatus and a magnetic stirrer. A solution of 18 ml of Exxsol D40 containing the mixture M was then introduced into the reactor. In each case, the mass of polymer (m_{P}) and the mass of isostearic acid (m_{ISA}) introduced were adapted in order to maintain in the mixture a fixed molar ratio (COOH carried by the polymers/total CeO₂), equal to 0.8. The corresponding masses m_{P} and m_{ISA} are recorded in Table III below.

The resulting mixture was stirred at 60° C. for one hour. After stopping stirring and lowering the temperature to ambient temperature (25° C.), the mixture was allowed to settle for 12 hours. After settling, the aqueous phase was separated from the organic phase by removing the organic phase by means of a pipette.

Each of the organic phases so removed constitutes an organosol, the stability of which was tested in a hot/cold cycle (−20° C.; +90° C.).

To that end, the various samples of organosols which had been taken were placed in an oven and subjected to a series of temperature cycles, each of those cycles being defined as follows:
temperature maintained at 90° C. for one hour;
temperature lowered from 90° C. to −20° C. over a period of one hour;
temperature immediately increased from −20° C. to +90° C. over a period of one hour (before the start of following cycle: new plateau of one hour—fall to −20° C. and rise to +90° C.).

For each sample, the time is noted at which the organic sols become cloudy and the formation of a white deposit, which is characteristic of the loss of stability, is observed. The period of stability, prior to the appearance of cloudiness and of the white deposit, which was observed in each case is recorded in Table III below.

TABLE III
Compared stability tests of different organosols
of CeO₂ particles in Exxsol D40

| Content of polymer in | Mass of | Mass of isostearic | Period of | |
|---|---|---|---|---|
| the mixture M | polymer (m_{P}) | acid (m_{AIS}) | stability | |
| No polymer | — | 0.137 g | 48 | h |
| (control) | | | | |
| 10 mol. % | 0.066 g | 0.123 g | 72 | h |
| 25 mol. % | 0.165 g | 0.103 g | 96 | h |
| 50 mol. % | 0.329 g | 0.068 g | 100 | h |
| 75 mol. % | 0.494 g | 0.034 g | 216 | h |
| 100 mol. % | 0.659 g | — | 240 | h |

This example shows that the period of stability doubles when 25 mol. % of the isostearic acid of the control is replaced by the polymer of Example A1. It is multiplied by 5 when 100% of the isostearic acid is replaced by the polymer.

### Comparison Example 2

### Comparison of the Properties of Block Copolymers According to the Invention and of Random Copolymers Having the Same Composition

Preparation of a Random Copolymer P_{RAND} Based on 2-ethylhexyl acrylate and acrylic acid Units Having Generally the Same Composition as the Block Copolymer of Examples A1 and A2

For the purposes of comparison, a random polymer based on acrylic acid and 2-ethylhexyl acrylate units was synthesised under the following conditions.

99.4 g of ethanol, 18.51 g of O-ethyl-S-(1-methoxycarbonyl)ethyl)xanthate (CH₃CHCO₂CH₃)S(C═S)OEt, 200 g of 2-ethylhexyl acrylate and 11.11 g of acrylic acid are introduced into a 500 ml glass reactor, maintained under argon, equipped with an impeller-type stirrer and a cooling apparatus.

The solution is brought to a temperature of 75° C., and 2.26 g of azo-bis-(methylisobutyronitrile) (AMBN) are added to the reaction mixture. After three hours' reaction, a further 0.056 g of AMBN is added to the reaction. The reaction is maintained for a further 5 hours at that temperature after the last addition of AMBN.

At the end of the reaction, ¹H NMR analysis indicates total conversion of the monomers. The number-average molar mass Mn of the resulting polymer, as measured by steric exclusion chromatography in THF (calibration with polystyrene), is 2300 g/mol.

Tests of the Transfer of the CeO₂ Particles from an Aqueous Sol to butyl acetate Using the Random Polymer P_{RAND}

Into a 500 ml reactor equipped with a cooling apparatus and an anchor-type mechanical stirrer there were introduced 100 ml of an aqueous sol of CeO₂ at 20 g/litre, as used in Example B1, and then a solution of 6.47 g of copolymer A9 in 100 ml of butyl acetate is introduced into the reactor.

The relative quantities of polymer and of CeO₂ used in the mixture so prepared correspond to a molar ratio (COOH carried by the polymers/total CeO₂) of 0.4.

The mixture was stirred at 60° C. for 6 hours. After stopping stirring and lowering the temperature to ambient temperature, the mixture was allowed to settle for one night. After settling, the aqueous phase was separated from the organic phase by withdrawing the aqueous phase through the valve at the bottom of the reactor.

The melting loss measured on the completely dried organosol enables it to be established that the rate of transfer is 11.1%.

The same protocol was carried out, but this time using 12.73 g of polymer instead of 6.47 g, in order to obtain a molar ratio (COOH carried by the polymers/total CeO₂) of 0.8. There was thus obtained a transfer yield (determined on the basis of measurement of the melting loss of the completely dried organosol) of 25.7%.

The very low rates of transfer obtained when using the polymer P_{RAND} clearly show that this random polymer is a mediocre phase-transfer agent, which gives much lower transfer yields than with the use of the polymers of Examples A1 and A2 (see Examples B1 to B4 above, where the yield is more than 90%).

1-36. (canceled)

37. A stabilized dispersion of mineral particles within an organic dispersing medium, comprising, as agents for stabilizing the dispersion, amphiphilic block polymers P which comprise:
a hydrophilic block A containing groups R^{A} capable of developing interactions with the surface of said particles; and
at least one hydrophobic block B bonded to the hydrophilic block A and having an affinity for the organic dispersing medium.

38. The particle dispersion as defined by claim 37, wherein said mineral particles are based on at least one mineral oxide.

39. The particle dispersion as defined by claim 38, wherein said mineral particles are based on SiO₂, CeO₂, TiO₂, ZrO₂, Al₂O₃, Fe₂O₃, or on a mixture thereof.

40. The particle dispersion as defined by claim 37, having a content of mineral particles ranging from 1% to 15% by mass, based on the total mass of the dispersion.

41. The particle dispersion as defined by claim 37, wherein the size of the mineral particles dispersed therein, without taking account of any layer of organic species surrounding same, ranges from 1 to 70 nm.

42. The particle dispersion as defined by claim 37, wherein said organic dispersing medium is a polar medium.

43. The particle dispersion as defined by claim 37, wherein said mineral particles have a negatively charged surface, and wherein all or some of the groups R^{A} of block A of the polymers P are cationic groups.

44. The particle dispersion as defined by claim 43, wherein said mineral particles are based on silica, and wherein the groups R^{A} are ammonium groups or quaternary amines.

45. The particle dispersion as defined by claim 37, wherein said mineral particles have a positively charged surface, and wherein all or some of the groups R^{A} of block A of the polymers P are anionic groups.

46. The particle dispersion as defined by claim 45, wherein block A of the polymers P comprises carboxylate, sulfate, sulfonate, phosphonate or phosphate groups.

47. The particle dispersion as defined by claim 45, wherein said mineral particles are based on cerium oxide CeO₂.

48. The particle dispersion as defined by claim 46, wherein block A comprises groups —COOH, some of which optionally have been ionized to the carboxylate state (—COO⁻).

49. The particle dispersion as defined by claim 48, wherein block A is a polyacrylate or poly(acrylic acid) block, a poly(styrenesulfonate) block, a poly(vinylphosphonic acid) block or a poly(acrylamido-methylpropanesulfonic acid) block.

50. The particle dispersion as defined by claim 37, wherein the polymers P for stabilizing the dispersion comprise diblock polymers constituted by an association of the hydrophilic block A and the hydrophobic block B, having the schematic formula A-B.

51. The particle dispersion as defined by claim 37, wherein the polymers P comprise copolymers having a plurality of hydrophobic blocks covalently bonded to the hydrophilic block A.

52. The particle dispersion as defined by claim 51, wherein the copolymers having a plurality of hydrophobic blocks covalently bonded to the hydrophilic block A comprise:
block polymers of the triblock type, of formula B1-A-B2, wherein each of the groups B1 and B2 represents a hydrophobic block of type B;
comb-type polymers in which a plurality of hydrophobic blocks of type B are bonded, as side chains, to the hydrophilic block A.

53. The particle dispersion as defined by claim 37, wherein the polymers P statistically comprise an average number of groups R^{A} greater than 1 within block A.

54. The particle dispersion as defined by claim 37, wherein the polymer P has a molecular mass of less than 10,000 g/mol.

55. The particle dispersion as defined by claim 37, wherein, in the polymers P, the mass ratio (hydrophilic block A/block(s) B) ranges from 0.02 to 0.5.

56. The particle dispersion as defined by claim 37, wherein the molecular mass of block A ranges from 50 to 5,000 g/mol, and wherein the molecular mass of each of the hydrophobic groups B is from 500 to 8,000 g/mol.

57. The particle dispersion as defined by claim 37, wherein the mass ratio (particles/polymer) is greater than or equal to 0.2.

58. The particle dispersion as defined by claim 37, wherein the molar ratio (groups R^{A} in the hydrophilic block A/mineral constituent of the particles) is greater than or equal to 02.

59. The particle dispersion as defined by claim 37, wherein the mass ratio (polymers/solvent) is greater than or equal to 0.005.

60. The particle dispersion as defined by claim 37, wherein the polymers P are polymers that are obtained according to a controlled free-radical polymerization process comprising the following successive steps:
(e1) a first polymer block functionalized at the chain end is formed by bringing into contact:
at least one ethylenically unsaturated monomer,
at least one free radical source, and
at least one xanthate, dithioester, thioether-thione or dithiocarbamate; and then
(e2) a second block is formed on the first polymer block functionalized at the chain end obtained in step (e1), by reacting the resulting polymer with new ethylenically unsaturated monomer and a free radical source.

61. The particle dispersion as defined by claim 60, wherein the polymers P are obtained by steps (e1) and (e2) and by employing xanthates carrying an O-ethyl or O-trifluoroethyl group.

62. The particle dispersion as defined by claim 60, in which the particles that are present have a negative surface charge, and wherein the polymers P are block polymers selected from among poly(butyl acrylate)-poly(quaternized 2-dimethylaminoethyl acrylate); poly(2-ethylhexyl acrylate)-poly(quaternized 2-dimethylaminoethyl acrylate); and poly(2-ethylhexyl acrylate)-poly(quaternized p-chloromethylstyrene).

63. The particle dispersion as defined by claim 60, wherein the particles have a positive surface charge, and wherein the polymers P are block polymers selected from among poly(butyl acrylate)-poly(acrylic acid); poly(2-ethylhexyl acrylate)-poly(acrylic acid); poly(2-ethylhexyl acrylate)-poly(styrenesulfonate); poly(butyl acrylate)-poly(styrenesulfonate); poly(isooctyl acrylate)-poly(acrylic acid); and poly(2-ethyl-hexyl acrylate)-poly(vinylphosphonic acid).

64. The particle dispersion as defined by claim 63, wherein the polymers P are diblock block polymers poly(acrylic acid)-poly(2-ethylhexyl acrylate) (PAA-P2EHA).

65. A diblock block polymer poly(acrylic acid)-poly(2-ethylhexyl acrylate) (PAA-P2EHA), useful as a stabilizing agent in a dispersion as defined by claim 64.

66. A process for the preparation of a particle dispersion as defined by claim 37, wherein said organic dispersing medium is hydrophobic, said process comprising a step (A) which comprises contacting an aqueous suspension of the particles with the hydrophobic organic medium in the presence of the amphiphilic block polymers P, thus transferring the particles from the aqueous phase to the hydrophobic medium in the form of an organic suspension stabilized by the polymers.

67. The process as defined by claim 66, wherein the initial aqueous suspension in step (A) has a concentration of particles of from 1 to 100 g/l.

68. The process as defined by claim 66, wherein the particles dispersed in the initial aqueous suspension in step (A) have an average hydrodynamic diameter of from 1 to 200 nm.

69. A composition dispersible in an organic medium to form a dispersion of mineral particles according to claim 37, said composition comprising mineral particles and amphiphilic block polymers P, and said composition being obtained by removal, by evaporation or other means, of the organic medium present in a dispersion of mineral particles.

70. A process for the preparation of the composition as defined by claim 69 by evaporation of the organic medium from a dispersion of mineral particles.

71. A process for the preparation of a dispersion of mineral particles, in a hydrophobic or non-hydrophobic organic medium, said process comprising a step (B) in which a composition according to claim 69 is dispersed in said organic medium.

72. A solvent-containing composition comprising the particle dispersion as defined by claim 37.

74. A catalyzed reaction in a solvent medium, said catalyst comprising the particle dispersion as defined by claim 37.
